(19) United States
(12) Patent Application Publication
(10) Pub. No.: US 2026/0159749 A1
(43) Pub. Date: Jun. 11, 2026

(54) MATERIALS AND METHODS TO ENHANCE MINERAL SCALE DISSOLUTION RATES

(71) Applicant: Swellfix UK Limited, Westhill, Aberdeenshire (GB)

(72) Inventors: Li JIANG, Katy, TX (US); Suzanne STEWART, Cypress, TX (US); Jonathan ABBOTT, Aberdeen (GB)

(73) Assignee: Swellfix UK Limited, Westhill, Aberdeenshire (GB)

(21) Appl. No.: 18/708,049

(22) PCT Filed: Nov. 9, 2022
(86) PCT No.: PCT/GB2022/052842

§ 371 Date: May 7, 2024

(30) Foreign Application Priority Data
Nov. 9, 2021 (GB) 2116098.1

(51) Int. Cl. C09K 8/528; C09K 8/536; E21B 41/02

(52) U.S. Cl. CPC C09K 8/528; C09K 8/536; E21B 41/02

(57) ABSTRACT

A composition capable of dissolving inorganic scale in a bore comprises at least one chelating agent and at least one additive capable of enhancing the rate of dissolution of the inorganic scale in the bore. In some embodiments, the at least one additive comprises at least one non-ionic surfactant. In some embodiments, the at least one additive comprises one or more gas generation agents. In some embodiments, the at least one additive comprises at least one biosurfactant.

### FIELD OF THE INVENTION

The present invention relates to compositions and methods for removing scale deposits in a bore. In particular, but not exclusively, the invention relates to compositions and methods for enhancing the rate of dissolution of inorganic scale in a bore.

### BACKGROUND

The production of hydrocarbons from a formation is associated with a number of problems that may reduce, or in extreme cases interrupt, production.

One such problem is the formation of scale deposits on the surface of a bore, e.g. a wellbore. The term “bore” will be herein understood in a general sense and encompasses the bore itself, that is the drilled hole or borehole including any cased or uncased (“open”) portion of the well, as well as any equipment that may be present within the well, such as pipes, tubulars (e.g. tubulars for logging, completion and production, or surface tubulars), linings, casings, pumps, valves, perforations, and the like. The term “bore” will also herein be understood to include any equipment associated with a well, including subsea equipment such as flowlines, e.g. offshore, subsea or under water flowlines and/or pipelines. The bore may be one which can accommodate flow in any system, equipment or infrastructure. For example, the bore may be defined by equipment and/or infrastructure associated with a wellbore (for example within and/or externally connected to a wellbore). In this example a wellbore may be provided to support the material extraction from or injection into a subterranean region. The bore may be defined by pipe infrastructure (e.g., tubing strings, pipelines, manifolds, connectors etc.). Such pipe infrastructure may be located topside, subsea, subterranean and/or the like, and may be for use in any flow application. The pipe infrastructure may be associated with a wellbore, for example located within a wellbore and/or externally connected to a wellbore. The pipe infrastructure may be provided for applications unrelated to wellbores, such as in the transport of a material (e.g., a liquid and/or a gas) between two locations. The bore may be defined by a drilled bore formed in a body, such as a geological body.

During production of a reservoir, a mixture of fluids is typically produced, including hydrocarbons in the forms of liquid, gas or condensate and reservoir waters. Reservoir waters typically have a high concentration of dissolved minerals under subterranean conditions. During production, changes in the environment (e.g. pressure (hence fluid flow rates) or temperature) and/or interaction or incompatibility with injections fluids (typically injection waters or brines) can cause inorganic compounds to precipitate and deposit on surfaces of the wellbore or equipment thereof. This represents a widespread and significant threat to well flow assurance and ultimately to well productivity.

The main types of “mineral” or “inorganic” scale include compounds (typically salts) of carbonates, sulfates, sulfides, phosphates, silicates, chlorides, chlorites and hydroxides.

In order to prevent or reduce the incidence of inorganic scales, scale inhibitors are often added to the injection fluids, or injected deep into the formation. However, even with the use of scale inhibitors, the occurrence of scale deposits is common.

In order to remove scale deposits, it is known to use scale dissolvers to dissolve such scale deposits. A common class of scale dissolvers relates to chelating agents. However, chelating ligand chemistries typically suffer from kinetically slow reactions believed to be at least partially due to the near static scale-fluid interface at a severely limited exposure of scale surface area in downhole environments. An example of the treatment of a subterranean formation with a chelating agent is disclosed in U.S. Pat. No. 9,745,509B2 (NASR-EL-DIN et al).

U.S. Ser. No. 10/005,955B2 (BEUTERBAUGH et al) discloses a foamed chelating agent treatment fluid that includes: an aminopolycarboxylic acid chelating agent, an aqueous base fluid, a gas, and a foaming agent. In particular, U.S. Ser. No. 10/005,955B2 discloses the use of foamed chelating agent treatment fluids in which the chelating agent is foamed with a gas and an amphoteric surfactant foaming agent, as part of an acid treatment procedure. The purpose of the amphoteric surfactant is to stabilise the composition at elevated temperatures.

U.S. Pat. No. 7,156,177B2 (JONES et al) discloses a scale dissolver fluid for dissolving scale in a subterranean hydrocarbon-bearing formation, the fluid comprising an effective amount of a scale dissolver formulation and an effective amount of anionic or cationic viscoelastic surfactants for controlling the viscosity of the fluid, particularly in high salinity environments.

It is an object of the invention to address and/or mitigate one or more problems associated with the prior art.

It is an object of the invention to enhance the rate of dissolution of inorganic scale in a wellbore

### SUMMARY

According to a first aspect there is provided a composition capable of dissolving inorganic scale in a bore, the composition comprising:
at least one chelating agent; and
at least one additive capable of enhancing the rate of dissolution of the inorganic scale in the bore.

Advantageously, the at least one additive may help enhance the rate of dissolution of the inorganic scale within the bore, without the need for cumbersome and expensive mechanic agitation means.

The at least one additive may comprise one or more non-ionic surfactants.

Thus, in a second aspect, there is provided a composition capable of dissolving inorganic scale in a bore, the composition comprising:
at least one chelating agent; and
at least one non-ionic surfactant.

Advantageously, the provision of one or more non-ionic surfactants allows the formation of micro- and/or nano-foams in situ by encapsulating entrained air or gas in the bulk of the composition. Without wishing to be bound by theory, it is believed that the micro- and/or nano-foams generated in situ will migrate within the fluid in the wellbore, e.g. within the injected composition and/or fluid, due to the pressure differential along bore trajectory. Thus, the addition of a non-ionic surfactant in the composition may help generate fluid movement at the scale-fluid interface and/or promote interfacial mass transfer of both reactant(s) and product(s), thus accelerating the dissolution of the inorganic scale.

As such, in contrast to the merely static stabilisation provided by ionic surfactants in the prior art, the addition of a non-ionic surfactant in the present composition provides a dynamic effect by forming micro- and/or non-foams, which causes subsequent movement along the bore trajectory driven by pressure differential resulting in improved agitation in an otherwise quiescent fluid body which, in turn, enhances scale dissolution rate.

In contrast, charged (anionic or cationic) surfactants tend to form foams of larger size and which therefore would not achieve the effect provided by the present composition.

The term “micro-foam” may refer to foams having an average bubble size in the range of about 1 to about 999 μm, e.g. about 2 to about 500 μm.

The term “nano-foam” may refer to foams having an average bubble size in the range of about 1 to about 999 nm, e.g. about 2 to about 500 nm.

The composition may be free of ionic surfactants. In other words, the composition may include at least one surfactant, where the at least surfactant consists of or consists essentially of at least one non-ionic surfactant. Advantageously, this may allow the formation of micro- and/or nano-foams in situ by encapsulating entrained air or gas in the bulk of the composition, causing movement thereof, and thus agitation, along the bore trajectory driven by pressure differential.

The amount of the at least one non-ionic surfactant in the composition may be about 0.001 to about 10 wt % of the composition, e.g. about 0.01 to about 5 wt %, about 0.1 to about 1 wt %.

Thus, the composition capable of dissolving inorganic scale in a bore may comprise:
at least one chelating agent in an amount of about 0.01 to about 50 wt % of the composition; and
at least one non-ionic surfactant in an amount of about 0.001 to about 10 wt % of the composition.

The at least one non-ionic surfactant may comprise one or more biosurfactants.

Advantageously, the provision of at least one biosurfactant may help remove any hydrocarbons that may be present on and/or may have saturated the surface of the scale deposit. Thus, the addition of at least one biosurfactant may enhance the rate of dissolution of the inorganic scale within the bore by removing any hydrocarbons that would otherwise prevent or hinder the reaction between interaction between the chelating agent and the inorganic scale.

The inventors have also discovered that biosurfactants may be capable of penetrating deeper into a rock formation than conventional surfactants, and thus may be able to clean undesirable hydrocarbons deposits more effectively than conventional surfactants.

The at least one biosurfactant may comprise a glycolipid. For example, the at least one biosurfactant may comprise one or more glycolipids selected from the group consisting of sophorolipids, rhamnolipids, glycoglycerolipids, and mannosylerythritol lipids. The at least one biosurfactant may comprise a sophorolipid such as Zymol® (Tendeka), or JBR320® (JENEIL Biotech), or BERO® (ZFA Tech).

The amount of the at least one biosurfactant in the composition may be about 0.001 to about 10 wt % of the composition.

The at least one additive may comprise one or more gas generation agents.

Thus, in a third aspect, there is provided a composition capable of dissolving inorganic scale in a bore, the composition comprising:
at least one chelating agent; and
at least one gas generation agent.

Advantageously, the provision of one or more gas generation agents allows the generation of gas bubbles in situ, and in particular at the scale-fluid interface. Without wishing to be bound by theory, it is believed that the addition of a gas generation agent may therefore help generate fluid movement at the scale-fluid interface and/or promote interfacial mass transfer of both reactant(s) and product(s), thus accelerating the dissolution of the inorganic scale.

Further, and advantageously, the gas generation reaction may be catalysed by the freshly generated cations formed by the scale dissolution process.

Thus, gas generation from the addition of at least one gas generation agent may be self-catalysed during scale dissolution at the surface of the scale deposit, thus providing a localised agitation helping to accelerate the interfacial mass transfer, and in turn the scale dissolution rate.

Advantageously, the ability of the present composition to generate gas in situ may also allow for the controlled management of fluid density during the treatment of the bore. The control and management of treatment fluid density during pumping and soaking in a wellbore, e.g. in a tubular, is important to ensure that the treatment fluid remains inside the tubular and in contact with the scale targeted for removal. Control of fluid density through tuning the degree of gas generation while pumping enables the fluid density to remain balanced in relation to the reservoir pressure thereby preventing or reducing the loss of scale treatment fluid to the formation during the soaking time. Preventing the loss of fluid and increasing the soaking time inside the tubing maximizes the amount of scale removed and can minimize the total volume of the scale treatment.

The amount of the at least one gas generation agent in the composition may be about 0.1 to about 30 wt % of the composition.

Thus, the composition capable of dissolving inorganic scale in a bore may comprise:
at least one chelating agent in an amount of about 0.01 to about 50 wt % of the composition; and
at least one gas generation agent in an amount of about 0.1 to about 30 wt % of the composition.

The composition, e.g. the at least one additive, may comprise at least one non-ionic surfactant and at least one gas generation agent.

By such provision, the at least one non-ionic surfactant may help entrap or encapsulate gas bubbles generated by the at least one gas generation agent into micro- and/or nano-bubbles, therefore further enhancing localised agitation.

Thus, the composition capable of dissolving inorganic scale in a bore may comprise:
at least one chelating agent in an amount of about 0.01 to about 50 wt % of the composition;
at least one non-ionic surfactant in an amount of about 0.001 to about 10 wt % of the composition; and
at least one gas generation agent in an amount of about 0.1 to about 30 wt % of the composition.

The at least one additive may comprise one or more biosurfactants.

Thus, in a fourth aspect, there is provided a composition capable of dissolving inorganic scale in a bore, the composition comprising:
at least one chelating agent; and
at least one biosurfactant.

Advantageously, the provision of at least one biosurfactant may help remove any hydrocarbons that may be present on and/or may have saturated the surface of the scale deposit. Thus, the addition of at least one biosurfactant may enhance the rate of dissolution of the inorganic scale within the bore by removing any hydrocarbons that would otherwise prevent or hinder the reaction between interaction between the chelating agent and the inorganic scale.

The inventors have also discovered that biosurfactants may be capable of penetrating deeper into a rock formation than conventional surfactants, and thus may be able to clean undesirable hydrocarbons deposits more effectively than conventional surfactants.

The at least one biosurfactant may comprise a glycolipid. For example, the at least one biosurfactant may comprise one or more glycolipids selected from the group consisting of sophorolipids, rhamnolipids, glycoglycerolipids, and mannosylerythritol lipids. The at least one biosurfactant may comprise a sophorolipid such as Zymol® (Tendeka), or JBR320® (JENEIL Biotech), or BERO® (ZFA Tech).

The amount of the at least one biosurfactant in the composition may be about 0.001 to about 10 wt % of the composition.

Thus, the composition capable of dissolving inorganic scale in a bore may comprise:
at least one chelating agent in an amount of about 0.01 to about 50 wt % of the composition; and
at least one biosurfactant in an amount of about 0.001 to about 10 wt % of the composition.

The following features may apply to any of the aforementioned aspects.

The term “bore” will be herein understood in a general sense and encompasses the bore itself, that is the drilled hole or borehole including any cased or uncased (“open”) portion of the well, as well as any equipment that may be present within the well, such as pipes, tubulars (e.g. tubulars for logging, completion and production, or surface tubulars), linings, casings, pumps, valves, perforations, and the like. The term “bore” will also herein be understood to include any equipment associated with a well, including subsea equipment such as flowlines, e.g. offshore, subsea or under water flowlines and/or pipelines. The bore may be one which can accommodate flow in any system, equipment or infrastructure. For example, the bore may be defined by equipment and/or infrastructure associated with a wellbore (for example within and/or externally connected to a wellbore). In this example a wellbore may be provided to support the material extraction from or injection into a subterranean region. The bore may be defined by pipe infrastructure (e.g., tubing strings, pipelines, manifolds, connectors etc.). Such pipe infrastructure may be located topside, subsea, subterranean and/or the like, and may be for use in any flow application. The pipe infrastructure may be associated with a wellbore, for example located within a wellbore and/or externally connected to a wellbore. The pipe infrastructure may be provided for applications unrelated to wellbores, such as in the transport of a material (e.g., a liquid and/or a gas) between two locations. The bore may be defined by a drilled bore formed in a body, such as a geological body.

The composition may comprise a carrier such as a dispersing medium or solvent. The carrier may be aqueous or non-aqueous.

The composition may comprise an aqueous medium or carrier, e.g. water, brine, or the like.

The composition may comprise the carrier, e.g. water, in an amount of about 10 to about 90 wt % of the composition.

Preferably, the at least one additive may be capable of enhancing the rate of dissolution of the inorganic scale under conditions typical of a wellbore environment.

Typically, the at least one additive may be capable of enhancing the rate of dissolution of the inorganic scale under one or more of the following conditions:
A pH of about 9-12, typically about 10-11;
A temperature of about 100-300° F. (about 37-149° C.), typically about 100-250° F. (about 37-121° C.); and/or
A pressure of about 2000-20000 psi (about 138-1379 bars), typically about 3000-15000 psi) (about 207-1034 bars).

The at least one chelating agent may comprise an aminopolycarboxylic acid chelating agent, ethylenediaminetetraacetic acid (EDTA), diethylenetriamine pentaascetic acid (DTPA), nitrilotriacetic acid (NTA), tetraethylenetetraamine (TETA), ethylenediaminedi(o-hydroxyphenylacetic) acid (EDDHA), glucoheptonic acid, gluconic acid, citric acid, hydroxamates, pyridinecarboxylic acids, polymeric versions of the above species or combination thereof. Alternatively, macrocyclic ligands including nitrogen and/or oxygen binding sites can also be used as effective chelating agents:

In an embodiment, the at least one chelating agent may comprise ScaleFix SSDE® (Tendeka). The at least one chelating agent may comprise a mixture of ethylenediaminetetraacetic acid (EDTA) and diethylenetriamine pentaacetic acid (DTPA) in an aqueous medium.

Typically, the amount of the at least one chelating agent may be in the range of about 0.01 to about 50 wt % of the composition.

The composition may be free of gas. Whilst the composition may comprise a gas generation agent allowing the generation of gas bubbles in situ, and in particular at the scale-fluid interface, the absence of a separate gas or air injected with the composition may avoid the formation of macro-foams or large bubbles which may otherwise hinder the movement of micro- or nano-bubbles driven by pressure differential along the bore trajectory and at the inorganic scale surface.

The at least one non-ionic surfactant may comprise saturated or unsaturated ester derivatives.

The at least one non-ionic surfactant may comprise an optionally functionalised, e.g. aminated or hydroxylated, ester derivative of a saturated fatty acid, e.g. of a myristic, palmitic, or stearic acid.

The at least one non-ionic surfactant may comprise an optionally functionalised, e.g. aminated or hydroxylated, ester derivative of an unsaturated fatty acid, e.g. of a palmitic, palmitoleic, oleic, linoleic, or ricinoleic acid.

The at least one non-ionic surfactant may comprise an optionally functionalised, e.g. aminated or hydroxylated, ester derivative of a mixture of fatty acid compounds, e.g. of tallow oil, castor oil, or the like.

The at least one non-ionic surfactant may comprise an optionally functionalised, e.g. aminated or hydroxylated, ether derivative of a saturated fatty alcohol, e.g. of a myristic, palmitic or stearic alcohol.

The at least one non-ionic surfactant may comprise an optionally functionalised, e.g. aminated or hydroxylated, ether derivative of an unsaturated fatty alcohol, e.g. of a palmitic, palmitoleic, oleic, linoleic, or ricinoleic alcohol.

The at least one non-ionic surfactant may comprise an optionally functionalised, e.g. aminated or hydroxylated, ether derivative of a mixture of fatty alcohol compounds.

The at least one gas generation agent may comprise a carbonate compound, an ammonium compound, a urea compound, and/or a peroxide compound.

The at least one gas generation agent may comprise one or more carbonate salts. In such instance, the carbonate salt may be selected from a carbonate salt capable of generating a gas in situ under conditions typical of a wellbore environment. Typically, the carbonate salt may not include sodium carbonate or potassium carbonate. For example, US2020/0308472 (Purdy et al) discloses the use of a “scale removal enhancer” which may comprise, e.g., potassium carbonate. However, without wishing to be bound by theory, such carbonate compounds are believed to be inherently stable and typically may not decompose to generate gas in situ under conditions typical of a wellbore environment, but rather will remain as carbonates to recombine and generate new carbonate compounds with other cations.

The at least one gas generation agent may comprise one or more ammonium halide salts, e.g. an ammonium salt of chloride, bromide, fluoride, or iodide; ammonium carbonate; urea and derivatives thereof; hydrogen peroxide; a metal peroxide, e.g. a potassium, sodium or lithium peroxide; and/or organic peroxides such as linear or cyclic compounds containing one or more peroxide units per molecule.

The at least one gas generation agent may typically comprise one or more compounds selected from the list consisting of ammonium chloride, ammonium carbonate, urea, and hydrogen peroxide.

In an embodiment, the at least one gas generation agent may be urea.

According to a fifth aspect, there is provided a method of dissolving inorganic scale in a bore, the method comprising injecting in the bore a composition according to any of the first, second, third or fourth aspect.

The method may comprise forming of micro- and/or nano-foams in situ, e.g. by encapsulating entrained air or gas in the bulk of the composition. Without wishing to be bound by theory, it is believed that the micro- and/or nano-foams generated in situ will migrate within the fluid in the wellbore, e.g. within the injected composition and/or fluid, due to the pressure differential along bore trajectory. Thus, the addition of one or more additives, e.g. at least one non-ionic surfactant and/or at least one gas generation agent, in the composition may help generate fluid movement at the scale-fluid interface and/or promote interfacial mass transfer of both reactant(s) and product(s), thus accelerating the dissolution of the inorganic scale.

The method may comprise forming micro-foams in situ having an average bubble size in the range of about 1 to about 999 μm, e.g. about 2 to about 500 μm.

The method may comprise forming “nano-foam” in situ having an average bubble size in the range of about 1 to about 999 nm, e.g. about 2 to about 500 nm.

The method may further comprise providing agitation means in the bore, e.g. at or near the location of the inorganic scale to be removed. Thus, the present approach relating to enhancing the dissolution rate of inorganic scale using a chemical composition, may be combined with agitation techniques to accelerate scale removal, for example in the form of jarring, perforating, propellant, vibration tools and high pressure jetting, in order to further improve scale removal. Coiled tubing and chemical injection lines may be used for downhole delivery and controlled placement of the dissolver. Slickline, coiled tubing and chemical injection can enhance in situ gas generation by introducing additional reactants downhole during the treatment when required.

The features described in relation to any aspect of the invention may equally apply to any other aspect and, merely for brevity, are not repeated. For example, features described in relation to compositions can apply in relation to methods, and vice versa.

### DETAILED DESCRIPTION

As explained above, the present inventors have discovered compositions and methods which are capable of enhancing the dissolving rate of inorganic scale in a bore. Such compositions comprise:
at least one chelating agent; and
at least one additive capable of enhancing the rate of dissolution of the inorganic scale in the bore.

Advantageously, the use of the at least one such additive may help enhance the rate of dissolution of the inorganic scale within the bore, without the need for cumbersome and expensive mechanic agitation means.

Preferably, the at least one additive may be capable of enhancing the rate of dissolution of the inorganic scale under conditions typical of a wellbore environment.

Typically, the at least one additive may be capable of enhancing the rate of dissolution of the inorganic scale under one or more of the following conditions:
A pH of about 9-12, typically about 10-11;
A temperature of about 100-300° F. (about 37-149° C.), typically about 100-250° F. (about 37-121° C.); and/or
A pressure of about 2000-20000 psi (about 138-1379 bars), typically about 3000-15000 psi) (about 207-1034 bars).

The at least one additive may comprise one or more non-ionic surfactants.

Advantageously, the provision of one or more non-ionic surfactants allows the formation of micro- and/or nano-foams in situ by encapsulating entrained air or gas in the bulk of the composition. Without wishing to be bound by theory, it is believed that the micro- and/or nano-foams generated in situ will migrate within the fluid in the bore, e.g. within the injected composition and/or fluid, due to the pressure differential along bore trajectory. Thus, the addition of a non-ionic surfactant in the composition may help generate fluid movement at the scale-fluid interface and/or promote interfacial mass transfer of both reactant(s) and product(s), thus accelerating the dissolution of the inorganic scale.

As such, in contrast to the merely static stabilisation provided by ionic surfactants in the prior art, the addition of a non-ionic surfactant in the present composition provides a dynamic effect by forming micro- and/or non-foams, which causes subsequent movement along the bore trajectory driven by pressure differential resulting in improved agitation in an otherwise quiescent fluid body which, in turn, enhances scale dissolution rate.

In contrast, charged (anionic or cationic) surfactants tend to form foams of larger size and which therefore would not achieve the effect provided by the present composition.

The term “micro-foam” may refer to foams having an average bubble size in the range of about 1 to about 999 μm, e.g. about 2 to about 500 μm.

The term “nano-foam” may refer to foams having an average bubble size in the range of about 1 to about 999 nm, e.g. about 2 to about 500 nm.

The composition may be free of ionic surfactants. In other words, the composition may include at least one surfactant, where the at least surfactant consists of or consists essentially of at least one non-ionic surfactant. Advantageously, this may allow the formation of micro- and/or nano-foams in situ by encapsulating entrained air or gas in the bulk of the composition, causing movement therefore, and thus agitation, along the bore trajectory driven by pressure differential.

The amount of the at least one non-ionic surfactant in the composition may be about 0.001 to about 10 wt % of the composition, e.g. about 0.01 to about 5 wt %, about 0.1 to about 1 wt %.

Thus, the composition capable of dissolving inorganic scale in a bore may comprise:
at least one chelating agent in an amount of about 0.01 to about 50 wt % of the composition; and
at least one non-ionic surfactant in an amount of about 0.001 to about 10 wt % of the composition.

The at least one non-ionic surfactant may comprise saturated or unsaturated ester derivatives.

The at least one non-ionic surfactant may comprise an optionally functionalised, e.g. aminated or hydroxylated, ester derivative of a saturated fatty acid, e.g. of a myristic, palmitic, or stearic acid.

The at least one non-ionic surfactant may comprise an optionally functionalised, e.g. aminated or hydroxylated, ester derivative of an unsaturated fatty acid, e.g. of a palmitic, palmitoleic, oleic, linoleic, or ricinoleic acid.

The at least one non-ionic surfactant may comprise an optionally functionalised, e.g. aminated or hydroxylated, ester derivative of a mixture of fatty acid compounds, e.g. of tallow oil, castor oil, or the like.

The at least one non-ionic surfactant may comprise an optionally functionalised, e.g. aminated or hydroxylated, ether derivative of a saturated fatty alcohol, e.g. of a myristic, palmitic or stearic alcohol.

The at least one non-ionic surfactant may comprise an optionally functionalised, e.g. aminated or hydroxylated, ether derivative of an unsaturated fatty alcohol, e.g. of a palmitic, palmitoleic, oleic, linoleic, or ricinoleic alcohol.

The at least one non-ionic surfactant may comprise an optionally functionalised, e.g. aminated or hydroxylated, ether derivative of a mixture of fatty alcohol compounds.

Exemplary embodiments of the non-ionic surfactant include:
Aminated polyether tallow derivatives, such as Ultraoil Cl 3055® from Oxineto (Amines, N-tallow alkyltrimethylenedi-, propoxylated);
Polyether derivative of castor oil, such as Ultraric CSO200® from Oxineto (ethoxylated and propoxylated castor oil);
Polyether derivatives of stearic alcohol, such as Alkomol E10® from Oxineto (polypropylene stearyl ether);
RD-1096® from Stepan (fatty alcohol ethoxylates);
RD-1097® from Stepan (fatty alcohol ethoxylates);
Hostafrac SF13213® from Clariant (mixture including ethoxylated alcohols);
Hostafrac SF14414® from Clariant (mixture including Polyoxyethylene monobutyl ether, 1-deoxy-1-(methyl-(C8-10-(even)-alkanoyl)amino)-D-Glucitol, 1-deoxy-(methylamino)-, N-C12-14 acyl derivative of D-Glucitol, ethoxylated isotridecanol, 1-octanol, propylene glycol, and ethanol);
Esters of oleic acid, such as Manasorb SMO® from Synalloy (sorbitan monooleate) or Tween 80 ® from Synalloy (polyoxyethynene (20) sorbitan monooleate).

The at least one non-ionic surfactant may comprise a mixture of non-ionic surfactants.

In an embodiment, the mixture of non-ionic surfactants may comprise:
(i) about 20-35 wt % 1-propananium N-(carboxmethyl)-N,N-dimethyl-3-[(1-oxooctyl}amino]-, hydroxide, inner salt;
(ii) about 20-35 wt % (carboxymethyl)dimethyl-3-[(1-oxodecyl)amion]propylammonium hydroxide;
(iii) about 5-30 wt % 1-dodecene; and
(iv) about 1-5 wt % dodecene-1-sulfonic acid, sodium salt.

In an embodiment, the mixture of non-ionic surfactants may comprise, may consist essentially of or may consist of:
(v) about 20-45 wt % 1-propananium N-(carboxmethyl)-N,N-dimethyl-3-[(1-oxooctyl}amino]-, hydroxide, inner salt;
(vi) about 20-45 wt % (carboxymethyl)dimethyl-3-[(1-oxodecyl)amino]propylammonium hydroxide;
(vii) about 5-30 wt % 1-dodecene; and
(viii) about 1-5 wt % dodecene-1-sulfonic acid, sodium salt.

The at least one additive may comprise one or more gas generation agents.

Advantageously, the provision of one or more gas generation agents allows the generation of gas bubbles in situ, and in particular at the scale-fluid interface. Without wishing to be bound by theory, it is believed that the addition of a gas generation agent may therefore help generate fluid movement at the scale-fluid interface and/or promote interfacial mass transfer of both reactant(s) and product(s), thus accelerating the dissolution of the inorganic scale.

Further, and advantageously, the gas generation reaction may be catalysed by the freshly generated cations formed by the scale dissolution process. For example, gas generation associated with the gas generation agent ammonium carbonate can be represented by the following equation:

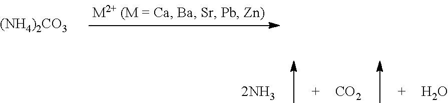

Without wishing to be bound by theory, the decomposition reaction of the gas generation agent is believed to be catalysed by the presence of freshly generated polyvalent (divalent in this case) cations, allowing the reaction to proceed through a pathway associated with a lower activation energy hurdle (i.e. at a lower temperature) and typically at a faster rate

Thus, gas generation from the addition of at least one gas generation agent may be self-catalysed during scale dissolution at the surface of the scale deposit, thus providing a localised agitation helping to accelerate the interfacial mass transfer at the interface, and in turn the scale dissolution rate.

Advantageously, the ability of the present composition to generate gas in situ may also allow for the controlled management of fluid density during the treatment of the bore. The control and management of treatment fluid density during pumping and soaking in a bore, e.g. in a tubular, is important to ensure that the treatment fluid remains inside the tubular and in contact with the scale targeted for removal. Control of fluid density through tuning the degree of gas generation while pumping enables the fluid density to remain balanced in relation to the reservoir pressure thereby preventing or reducing the loss of scale treatment fluid to the formation during the soaking time. Preventing the loss of fluid and increasing the soaking time inside the tubing maximizes the amount of scale removed and can minimize the total volume of the scale treatment.

The amount of the at least one gas generation agent in the composition may be about 0.1 to about 30 wt % of the composition.

Thus, the composition capable of dissolving inorganic scale in a bore may comprise:
at least one chelating agent in an amount of about 0.01 to about 50 wt % of the composition; and
at least one gas generation agent in an amount of about 1 to about 30 wt % of the composition.

The composition, e.g. the at least one additive, may comprise at least one non-ionic surfactant and at least one gas generation agent.

By such provision, the at least one non-ionic surfactant may help entrap or encapsulate gas bubbles generated by the at least one gas generation agent into micro- and/or nano-bubbles, therefore further enhancing localised agitation.

Thus, the composition capable of dissolving inorganic scale in a bore may comprise:
at least one chelating agent in an amount of about 0.01 to about 50 wt % of the composition;
at least one non-ionic surfactant in an amount of about 0.001 to about 10 wt % of the composition; and
at least one gas generation agent in an amount of about 0.1 to about 30 wt % of the composition.

The at least one gas generation agent may comprise a carbonate compound, an ammonium compound, a urea compound, and/or a peroxide compound.

The at least one gas generation agent may comprise one or more metal carbonate salts. In such instance, the carbonate salt may be selected from a carbonate salt capable of generating a gas in situ under conditions typical of a wellbore environment. Typically, the carbonate salt may not include sodium carbonate or potassium carbonate. For example, US2020/0308472 (Purdy et al) discloses the use of a “scale removal enhancer” which may comprise, e.g., potassium carbonate. However, without wishing to be bound by theory, such carbonate compounds are believed to be inherently stable and typically may not decompose to generate gas in situ under conditions typical of a wellbore environment, but rather will remain as carbonates to recombine and generate new carbonate compounds with other cations.

The at least one gas generation agent may comprise one or more ammonium halide salts, e.g. an ammonium salt of chloride, bromide, fluoride, or iodide; ammonium carbonate; urea or derivatives thereof; hydrogen peroxide; a metal peroxide, e.g. a potassium, sodium or lithium peroxide; and/or an organic peroxide such as linear or cyclic compounds containing one or more peroxide units per molecule.

The at least one gas generation agent may typically comprise one or more compounds selected from the list consisting of ammonium chloride, ammonium carbonate, urea, and hydrogen peroxide.

The at least one gas generation agent may comprise one or more urea compounds selected from the list consisting of 1,1-dimethylurea, 1,3-dimethylurea, 1,1-diethylurea, 1,3-diethylurea, 1,1-diallylurea, 1,3-diallylurea, 1,1-dipropylurea, 1,3-dipropylurea, 1,1-dibutylurea, 1,3-dibutylurea, 1,1,3,3-tetramethylurea, 1,1,3,3-tetraethylurea, 1,1,3,3-tetrapropylurea, 1,1,3,3-tetrabutylurea, ethyleneurea, propyleneurea, 1,3-dimethylpropyleneurea, 1,3-dimethylethyleneurea, or combinations thereof.

The at least one gas generation agent may comprise at least one organic peroxide. The organic peroxide may comprise a cyclic peroxide structure, for example, a cyclic peroxide structure having a ring structure of about 4 to about 16 atoms, e.g. a ring structure of about 5 to about 12 atoms, e.g. a ring structure of 6 to about 10 atoms. Typically, the cyclic peroxide structure may have the formula:

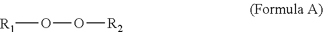

where R₁ and R₂ are independently alkylene groups that may join together to form the cyclic peroxide structure.

The cyclic peroxide structure may further comprise about 1 to about 6 additional oxygen atoms, e.g. about 2 to about 5 additional oxygen atoms, e.g. about 3 to about 4 additional oxygen atoms, in the cyclic structure.

The total number of oxygen atoms in the cyclic peroxide ring structure may be about 3 to 8, e.g. about 4 to 6. The additional oxygen atoms may be separated by one or more alkylene groups.

For example, the cyclic peroxide ring structure may comprise a cyclic peroxide ring containing 8 oxygen atoms in which each alkylene group is separated by two oxygen atoms.

The alkylene groups that form a part of the cyclic peroxide ring structure refer, for example, to a divalent aliphatic group or alkyl group, including linear and branched, saturated and unsaturated, and substituted and unsubstituted alkylene groups, and wherein heteroatoms, such as oxygen, nitrogen, sulfur, silicon, phosphorus, boron, Mg, Li, Ge, Cu, Fe, Ni, Pd, Pt and the like either may be present or absent in the alkylene group. For example, an alkylene group may represent a divalent structure that can be linear or branched, saturated or unsaturated, and substituted or unsubstituted and have a structure including from about 1 to about 20 atoms, such as from about 2 to about 15, or about 3 to about 10 atoms.

In an embodiment, the organic peroxide may include a peroxide compound represented by Formula (I):

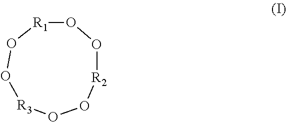

where R₁, R₂, and R₃, are independently optionally substituted alkylene groups.

An exemplary embodiment of a compound represented by Formula (I) may include 3,6,9-triethyl-3,6,9-trimethyl-1,4,7-triperoxonane, as represented by Formula (II):

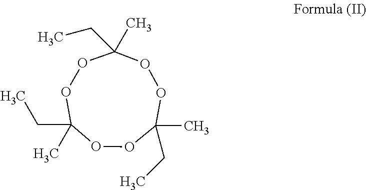 [SMILES: CCC1(C)OOC(C)(CC)OOC(C)(CC)OO1]

Further exemplary compounds represented by Formula (I) may include homologs of the compound of Formula (II) where the methyl and/or ethyl groups are replaced by a linear or branched alkyl group.

For example, homologs of the compound of Formula (II) may include structures in which one or more of the above methyl and/or ethyl groups, independently of one another, are replaced by a linear alkyl group having about 1 to about 20 carbon atoms, such as about 2 to about 16 carbon atoms, or about 4 to about 10 carbon atoms, which may or may not be substituted. In some embodiments, one or more of the above methyl and/or ethyl groups (of the compound of Formula (II)), independently of one another, may be replaced by hydrogen, a linear alkyl group, or branched alkyl group, the linear alkyl group or branched alkyl group having about 1 to about 20 carbon atoms, such as about 2 to about 16 carbon atoms, or about 4 to about 10 carbon atoms, which may or may not be substituted. Suitable linear or branched alkyl groups may include methyl, ethyl, n-propyl, isopropyl, n-butyl, isobutyl, tert-butyl, sec-butyl, tert-butyl, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, and a nonadecyl group, any of which may or may not be substituted.

Suitable linear or branched alkyl groups may also include any structural isomer of a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, and a nonadecyl group, any of which may or may not be substituted.

In another embodiment, the organic peroxide may include a peroxide compound represented by Formula (III):

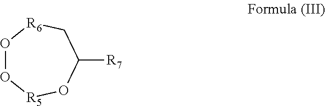

where R₅ and R₆ are independently alkylene groups, and R₇ is a hydrogen or a linear or branched alkyl group having about 1 to about 20 carbon atoms, such as about 2 to about 16 carbon atoms, or about 4 to about 10 carbon atoms, which may or may not be substituted. Suitable linear or branched alkyl groups may include those identified above with respect to Formulas (I) and (II).

An exemplary embodiment of a compound represented by Formula (III) may include 3,3,5,7,7-pentamethyl-1,2,4-trioxepane, the structure of which is represented by Formula (IV):

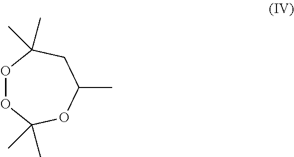

The substituents on the substituted alkylene and alkyl groups can be, for example, halogen atoms, ether groups, aldehyde groups, ketone groups, ester groups, amide groups, imide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, cyano groups, pyridine groups, pyridinium groups, guanidinium groups, amidine groups, imidazolium groups, carboxylate groups, carboxylic acid groups, urethane groups, urea groups, and mixtures thereof.

A molecule having “multiple linear peroxide moieties per molecule,” refers, for example, to a single molecule including at least about 2 peroxy structures represented by R₈—O—O—R₉ (Formula (B)), such as about 2 to about 8 peroxy structures in a single molecule, or about 4 to about 6 peroxy structures in a single molecule; where R₈ and R₉ are independently a hydrocarbon group, including linear and branched, saturated and unsaturated, and substituted and unsubstituted hydrocarbon groups, and wherein heteroatoms, such as oxygen, nitrogen, sulfur, silicon, phosphorus, boron, Mg, Li, Ge, Cu, Fe, Ni, Pd, Pt and the like either may be present or absent in the hydrocarbon group.

In embodiments, the at least 2 peroxy structures may be bonded together by at least one intervening:
(a) alkylene group, such as an alkylene group having 1 to about 40 carbon atoms, or about 4 to about 20 carbon atoms, or about 6 to about 10 carbon atoms, wherein hetero atoms either may or may not be present in the alkylene group;
(b) arylene group, such as an arylene group having about 5 to about 40 carbon atoms, or about 6 to about 14 carbon atoms, or about 6 to about 10 carbon atoms, wherein hetero atoms either may or may not be present in the arylene group;
(c) arylalkylene group, such as an arylalkylene group having about 6 to about 40 carbon atoms, or about 7 to about 22 carbon atoms, or about 7 to about 20 carbon atoms, wherein hetero atoms either may or may not be present in either or both of the alkyl portion and the aryl portion of the arylalkylene group; or
(d) alkylarylene group, such as an arylalkylene group having about 6 to about 40 carbon atoms, or about 7 to about 22 carbon atoms, or about 7 to about 20 carbon atoms, wherein hetero atoms either may or may not be present in either or both of the alkyl portion and the aryl portion of the alkylarylene group.

An “alkylene group” that may have multiple linear peroxide moieties bonded thereto refers, for example, to at least a divalent aliphatic group or alkyl group, such as a trivalent or tetravalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, Mg, Li, Ge, Cu, Fe, Ni, Pd, Pt and the like either may or may not be present in the alkylene group.

The term “arylene” refers, for example, to at least a divalent aromatic group or aryl group, such as a trivalent or tetravalent aromatic group or aryl group, including substituted and unsubstituted arylene groups, and wherein heteroatoms, such as O, N, S, P, Si, B, Li, Mg, Cu, Fe and the like either be present or absent in the arylene group. For example, an arylene group may have about 5 to about 40 carbon atoms in the arylene chain, such as from about 6 to about 14 or from about 6 to about 10 carbon atoms.

The term “arylalkylene” refers, for example, to at least a divalent arylalkyl group, such as a trivalent or tetravalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as O, N, S, P, Si, B, Li, Mg, Cu, Fe, and the like either may or may not be present in either the aryl or the alkyl portion of the arylalkylene group. For example, an arylalkylene group may have about 6 to about 40 carbon atoms in the arylalkylene chain, such as from about 7 to about 22 or from about 7 to about 20 carbon atoms.

The term “alkylarylene” refers, for example, to at least a divalent alkylaryl group, such as a trivalent or tetravalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as O, N, S, P, Si, Ge, B, Li, Mg, Cu, Fe, Pd, Pt and the like either may or may not be present in either the aryl or the alkyl portion of the alkylarylene group. For example, the alkylarylene may have about 6 to about 40 carbon atoms in the alkylarylene chain, such as from about 7 to about 22 or from about 7 to about 20 carbon atoms.

The substituents on the substituted hydrocarbon, alkylene, arylene, arylalkylene, and alkylarylene groups can be, for example, halogen atoms, ether groups, aldehyde groups, ketone groups, ester groups, amide groups, imide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, cyano groups, pyridine groups, pyridinium groups, guanidinium groups, amidine groups, imidazolium groups, carboxylate groups, carboxylic acid groups, urethane groups, urea groups, and mixtures thereof.

Molecules having multiple linear peroxide moieties per molecule may include 1,1- di(tert-butylperoxy)-3,3,5-trimethylcyclohexane, 2,5-dimethyl-2,5-di(tertbutylperoxy)hexyne-3, and 2,5,-dimethyl-2,5-di(tert butylperoxy)hexane, which are represented by Formulas (V), (VI), and (VII), respectively:

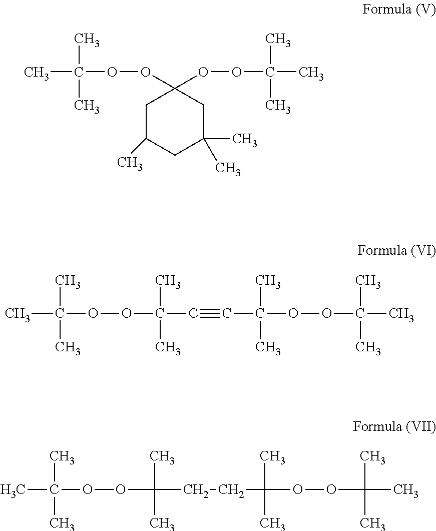

Advantageously, the at least one gas generation agent may be capable of generating a gas in situ under conditions typical of a wellbore environment.

The gas generation agent may decompose and/or dissociate in situ under conditions typical of a wellbore environment so as to generate a gas. Advantageously, the decomposition and/or dissociation reaction of the gas generation agent may be catalyzed by one or more catalyst compounds present or generated at or near the surface of the inorganic scale deposit. Typically, the decomposition and/or dissociation reaction of the gas generation agent may be catalyzed by one or more ions, e.g. divalent cations, such as Ca²⁺, Ba²⁺, Sr²⁺, which may be generated by dissolution of the inorganic scale, as explained above.

The at least one additive may comprise one or more biosurfactants.

Advantageously, the provision of at least one biosurfactant may help remove any hydrocarbons that may be present on and/or may have saturated the surface of the scale deposit. Thus, the addition of at least one biosurfactant may enhance the rate of dissolution of the inorganic scale within the bore by removing any hydrocarbons that would otherwise prevent or hinder the reaction between interaction between the chelating agent and the inorganic scale.

The inventors have also discovered that biosurfactants may be capable of penetrating deeper into a rock formation than conventional surfactants, and thus may be able to clean undesirable hydrocarbons deposits more effectively than conventional surfactants.

The at least one biosurfactant may comprise a glycolipid. For example, the at least one biosurfactant may comprise one or more glycolipids selected from the group consisting of sophorolipids, rhamnolipids, glycoglycerolipids, and mannosylerythritol lipids. The at least one biosurfactant may comprise a sophorolipid such as Zymol® (Tendeka), or JBR320® (JENEIL Biotech), or BERO® (ZFA Tech).

The amount of the at least one biosurfactant in the composition may be about 0.001 to about 10 wt % of the composition.

Thus, the composition capable of dissolving inorganic scale in a bore may comprise:
at least one chelating agent in an amount of about 0.01 to about 50 wt % of the composition; and
at least one biosurfactant in an amount of about 0.001 to about 10 wt % of the composition.

The composition may comprise a carrier such as a dispersing medium or solvent. The carrier may be aqueous or non-aqueous.

The composition may comprise an aqueous medium or carrier, e.g. water, brine, or the like.

The composition may comprise the carrier, e.g. water, in an amount of about 10 to about 90 wt % of the composition.

The at least one chelating agent may comprise an aminopolycarboxylic acid chelating agent, ethylenediaminetetraacetic acid (EDTA), diethylenetriamine pentaascetic acid (DTPA), nitrilotriacetic acid (NTA), tetraethylenetetraamine (TETA), ethylenediaminedi(o-hydroxyphenylacetic) acid (EDDHA), glucoheptonic acid, gluconic acid, citric acid, hydroxamates, pyridinecarboxylic acids, polymeric versions of the above species or combination thereof. Alternatively, macrocyclic ligands including nitrogen and/or oxygen binding sites as shown by examples below are also applicable as effective chelating agents:

| | |
|---|---|
| Tetraaza macrocyclic ligand and derivatives | 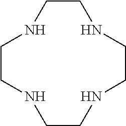 [SMILES: C1CNCCNCCNCCN1] |
| Crown ether and derivatives | 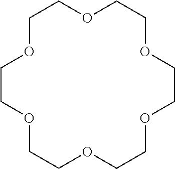 [SMILES: C1COCCOCCOCCOCCOCCO1] |
| Cryptand and derivatives | 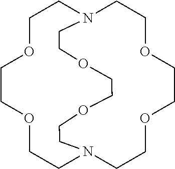 [SMILES: C1COCCN2CCOCCOCCN(CCO1)CCOCCOCC2] |
| Valinomycin and related natural antibiotics | 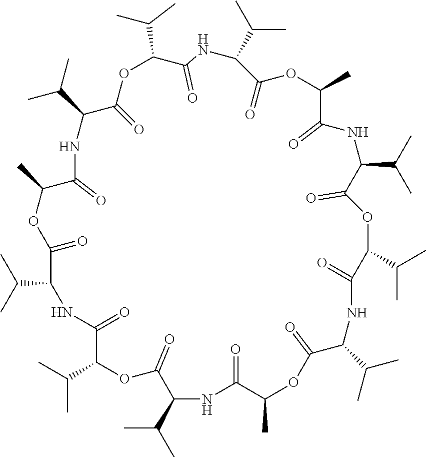 [SMILES: CC(C)[C@@H]1NC(=O)[C@H](C)OC(=O)[C@@H](C(C)C)NC(=O)[C@@H](C(C)C)OC(=O)[C@H](C(C)C)NC(=O)[C@H](C)OC(=O)[C@@H](C(C)C)NC(=O)[C@@H](C(C)C)OC(=O)[C@H](C(C)C)NC(=O)[C@H](C)OC(=O)[C@@H](C(C)C)NC(=O)[C@@H](C(C)C)OC1=O] |

In an embodiment, the at least one chelating agent may comprise ScaleFix SSDE® (Tendeka). The at least one chelating agent may comprise a mixture of ethylenediaminetetraacetic acid (EDTA) and diethylenetriamine pentaascetic acid (DTPA) in an aqueous medium.

Typically, the amount of the at least one chelating agent may be in the range of about 0.01 to about 50 wt % of the composition.

The composition may be free of gas. Whilst the composition may comprise a gas generation agent allowing the generation of gas bubbles in situ, and in particular at the scale-fluid interface, the absence of injected gas or air with the composition may avoid the formation of macro-foams or large bubbles which would otherwise hinder the movement of micro- or nano-bubbles driven by pressure differential along the bore trajectory and at the inorganic scale surface.

### EXAMPLES

### Example 1: Effect of Non-Ionic Surfactant

A strontium sulfate scale was retrieved from a Permian Basin well located in western Texas. The strontium sulfate scale was air dried, weighed and placed in measuring cylinders labelled as cylinders A and B. The scale samples were weighed in the range of 1.5 to 10 grams dependent on the availability of scale samples obtained from the field.

50 mL of the sulfate scale dissolver ScaleFix SSDE® (an aqueous mixture of chelating agents including ethylenediaminetetraacetic acid (EDTA) and diethylenetriamine pentaascetic acid (DTPA) at a concentration of 30 wt %) was poured into each of measuring cylinders A and B.

Into cylinder B, a non-ionic surfactant Ultraoil Cl 3055® ((Amines, N-tallow alkyltrimethylenedi-, propoxylated; obtained from Oxiteno) was added at a concentration of 200 ppm relative to the total volume of fluid in the cylinder.

Both cylinders were kept at 74° F. (23° C.) under static conditions for 5 hours.

While fluid in cylinder A was completely motionless, it was observed in cylinder B that there was a considerable amount of micro-bubbles forming and moving from bottom up.

At the end of the 5-hour treatment period, both scale samples were recovered from the respective cylinders, paper towel dried and followed up by another drying step under compressed air. Finally, the dried scale samples were weighed and the dissolution rates were calculated accordingly.

The results are presented in Table 1 below:

TABLE 1

| ID | Initial Mass (g) | End Mass (g) | Δ Mass (g) | Δ Mass (%) |
|---|---|---|---|---|
| SrSO₄ #1 | 9.4107 | 9.1705 | 0.2402 | 2.55% |
| SrSO₄ #2 | 7.7306 | 7.1901 | 0.4405 | 5.77% |

It can be seen that the presence of the non-ionic micro-foaming agents more than doubled the scale dissolution rate, which is believed to be due to the acceleration of the fluid mass transfer at the scale-fluid interface.

### Example 2: Experimentation with Other Non-Ionic Surfactants

In example 2, other non-ionic surfactants were tested as micro-foaming agents under otherwise identical conditions to those described in example 1.

| ID | Surfactant type | Source | Δ Mass (%) |
|---|---|---|---|
| SrSO₄ #3 | Ultraric CSO200 ® | Oxiteno | 5.41% |
| SrSO₄ #4 | Alkomol E10 ® | Oxiteno | 5.19% |
| SrSO₄ #5 | RD-1096 ® | Stepan | 5.05% |
| SrSO₄ #6 | RD-1097 ® | Stepan | 5.33% |
| SrSO₄ #7 | SF13213 ® | Clariant | 5.45% |
| SrSO₄ #8 | SF14414 ® | Clariant | 5.94% |
| SrSO₄ #12 | Manasorb SMO ® | Synalloy | 4.35% |
| SrSO₄ #13 | Tween 80 ® | Synalloy | 4.14% |

It can be seen that the other non-ionic micro-foaming agents also significantly increased the scale dissolution rate, which is believed to be due to the acceleration of the fluid mass transfer at the scale-fluid interface.

### Example 3: Effect of Gas Generation Agents

As in Example 1, a strontium sulfate scale was retrieved from a Permian Basin well located in western Texas. The strontium sulfate scale was air dried, weighed and placed in measuring cylinders labelled as A to F. The scale samples were weighed in the range of 1.5 to 10 grams dependent on the availability of scale samples obtained from the field.

50 mL of the sulfate scale dissolver ScaleFix SSDE® (an aqueous mixture of chelating agents including ethylenediaminetetraacetic acid (EDTA) and diethylenetriamine pentaascetic acid (DTPA) at a concentration of 30 wt %) was poured into each of measuring cylinders A to F.

Into cylinders B to F, a non-ionic surfactant Ultraoil Cl 3055® ((Amines, N-tallow alkyltrimethylenedi-, propoxylated; obtained from Oxiteno) was added at a concentration of 100 ppm relative to the total volume of fluid in the cylinder.

Into cylinders B to F was also added 100 ppm relative to the total volume of fluid in the cylinder of sophorolipid-based biosurfactant Zymol® (Tendeka), aimed at removing any hydrocarbons might have saturated at the surface the scales.

In addition, in measuring cylinders B to F, the following gas generating agents were added, respectively:
(B) sodium carbonate;
(C) ammonium chloride;
(D) ammonium carbonate;
(E) urea;
(F) hydrogen peroxide.

The above gas generation agents are able to decompose in situ so as to generate a gas. For example, gas generation associated with ammonium carbonate (D) can be represented as follows:

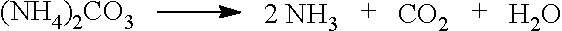

Such reactions are catalysed by the freshly generated metal cations generated by the scale dissolution process, in a manner exemplified by the following equation:

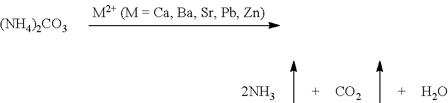

in which the decomposition reaction of the gas generating material, ammonium carbonate here as an example, is catalysed by the presence of freshly generated polyvalent (divalent in this case) cations, allowing the reaction to proceed through a pathway associated with a lower activation energy hurdle (i.e. at a lower temperature) and typically at a faster rate.

Thus, gas generation from the addition of at least one gas generation agent may be self-catalysed during scale dissolution at the surface of the scale deposit, thus providing a localised agitation helping to accelerate the interfacial mass transfer at the interface, and in turn the scale dissolution rate.

All cylinders were kept at 74° F. (23° C.) under static conditions for 3.5 hours.

While the fluid in cylinder A was completely motionless, it was observed in cylinders B-F that there was a considerable amount of micro-bubbles forming at the scale surface and moving from bottom up.

At the end of the 3.5-hour treatment period, all scale samples were recovered from the respective cylinders, paper towel dried and followed up by another drying step under compressed air. Finally, the dried scale samples were weighed and the dissolution rates were calculated accordingly.

The results are presented in Table 2 below:

TABLE 2

| ID | Gas generator | Δ Mass (%) |
|---|---|---|
| A - SrSO₄ #14 | None | 1.82% |
| B - SrSO₄ #15 | Sodium carbonate (1%) | 5.27% |
| C - SrSO₄ #16 | Ammonium chloride (1%) | 4.54% |
| D - SrSO₄ #17 | Ammonium carbonate (1%) | 12.56% |
| E - SrSO₄ #18 | Urea (1%) | 12.35% |
| F - SrSO₄ #19 | Hydrogen peroxide (1%) | 13.52% |

As can be seen from Table 2, the presence of a gas generation agent in addition to a micro-foaming agent and hydrocarbon cleaning biosurfactant caused a significant enhancement in the scale dissolution rate, particularly in the case of agents (D), (E) and (F).

It will be appreciated that the described embodiments are not meant to limit the scope of the present invention, and the present invention may be implemented using variations of the described examples.

1. A composition capable of dissolving inorganic scale in a bore, the composition comprising:
at least one chelating agent;
at least one gas generation agent; and
at least one non-ionic surfactant;
wherein the at least one non-ionic surfactant acts to entrap or encapsulate gas generated by the at least one gas generation agent into micro- and/or nano-bubbles.

2. A composition according to claim 1, wherein the at least one gas generation agent is capable of generating a gas in situ under conditions typical of a wellbore environment.

3. A composition according to claim 1, wherein the amount of the at least one non-ionic surfactant in the composition is about 0.001 to about 10 wt % of the composition, optionally about 0.01 to about 5 wt %, optionally about 0.1 to about 1 wt %.

4. A composition according to claim 1, wherein the at least one non-ionic surfactant comprises an optionally functionalised ester derivative of a saturated fatty acid, an optionally functionalised ester derivative of an unsaturated fatty acid, an optionally functionalised ether derivative of a saturated fatty alcohol, an optionally functionalised ether derivative of an unsaturated fatty alcohol, or mixtures or combinations thereof.

5. A composition according to claim 1, wherein the amount of the at least one gas generation agent in the composition is about 0.1 to about 30 wt % of the composition.

6. A composition according to claim 1, wherein the at least one gas generation agent comprises a carbonate compound, an ammonium compound, a urea compound, and/or a peroxide compound.

7. A composition according to claim 1, wherein the at least one gas generation agent comprises an ammonium halide salt; ammonium carbonate; urea or derivatives thereof; hydrogen peroxide; a metal peroxide, and/or a linear or cyclic organic peroxide compound containing one or more peroxide units per molecule.

8. A composition according to claim 6, wherein the at least one gas generation agent comprises one or more compounds selected from the list consisting of ammonium chloride, ammonium carbonate, urea, and hydrogen peroxide.

9. A composition according to a claim 1, wherein the gas generation reaction is catalysed by freshly generated cations formed by the scale dissolution process.

10. A composition according to claim 1, wherein the at least one non-ionic surfactant comprises at least one biosurfactant.

11. A composition according to claim 1, wherein the composition further comprises at least one biosurfactant.

12. A composition according to claim 11, wherein the amount of the at least one biosurfactant in the composition is about 0.001 to about 10 wt % of the composition.

13. A composition according to claim 10, wherein the at least one biosurfactant comprises a glycolipid.

14. A composition according to claim 1, wherein the amount of the at least one chelating agent is in the range of about 0.01 to about 50 wt % of the composition.

15. A composition according to claim 1, wherein the at least one chelating agent comprises an aminopolycarboxylic acid chelating agent, ethylenediaminetetraacetic acid (EDTA), diethylenetriamine pentaascetic acid (DTPA), nitrilotriacetic acid (NTA), tetraethylenetetraamine (TETA), ethylenediaminedi(o-hydroxyphenylacetic) acid (EDDHA), glucoheptonic acid, gluconic acid, citric acid, hydroxamates, pyridinecarboxylic acids, or polymeric versions thereof, a macrocyclic ligand including nitrogen and/or oxygen binding sites, or mixtures or combinations thereof.

16. A composition according to a claim 1, wherein the composition comprises an aqueous medium or carrier.

17. A composition according to claim 16, wherein the composition comprises an aqueous medium or carrier in an amount of about 10 to about 90 wt % of the composition.

18. A composition according to claim 1, wherein the composition is free of ionic surfactants.

19. A composition according to claim 1, wherein the composition is capable of enhancing the rate of dissolution of the inorganic scale under conditions typical of a wellbore environment.

20. A composition according to claim 19, wherein the at least one additive is capable of enhancing the rate of dissolution of the inorganic scale under one or more conditions selected from:
(i) a pH of about 9-12, typically about 10-11;
(ii) a temperature of about 100-300° F. (about 37-149° C.), optionally about 100-250° F. (about 37-121° C.); and/or
(iii) a pressure of about 2000-20000 psi (about 138-1379 bars), optionally about 3000-15000 psi (about 207-1034 bars).

21. A composition according to claim 1, wherein the composition is free of gas.

22. A method of dissolving inorganic scale in a bore, the method comprising injecting in the bore a composition according to claim 1.

23. A method according to claim 22, comprising forming micro- and/or nano-foams in situ.

24. A method according to claim 23, comprising encapsulating entrained air or gas in the bulk of the composition.

25. A method according to any one of claim 22, comprising forming micro-foams in situ having an average bubble size in the range of about 1 to about 999 μm, optionally about 2 to about 500 μm.

26. A method according to any one of claim 22, comprising forming “nano-foam” in situ having an average bubble size in the range of about 1 to about 999 nm, optionally about 2 to about 500 nm.
